(19) United States
(12) Patent Application Publication
(10) Pub. No.: US 2004/0256225 A1
(43) Pub. Date: Dec. 23, 2004

(54) Air purification system and device

(76) Inventors: Asaf Sokolowski, Tel Aviv (IL); Amram Fried, Tel-Mond (IL)

Correspondence Address: Edward Langer, c/o Shiboloth, Yisrneli, Roberts, Zisman & Co., 60th Floor, 350 Fifth Avenue, New York, NY, 10118, US

(21) Appl. No.: 10/837,522

(22) Filed: May 3, 2004

Related U.S. Application Data
(60) Provisional application No. 60/467,597, filed on May 5, 2003.

(51) Int. Cl. B01J 19/08; B01J 19/12; C25B 11/12

(52) U.S. Cl. 204/294; 422/186.04

(57) ABSTRACT

A carbon-based electrode device and a DDBD system for air purification and the production of ozone. The air treatment system is designed, in one embodiment thereof, to be operational in a double stage cycle involving the production of ozone-enriched air and the disintegration of air-borne pollutants, in a first stage; and the decomposition of residual ozone in the air, in a second stage. The multi-electrode crisscross array of the present invention features geometrical placement of the electrodes in triads to increase the efficiency of the system via two parameters, the close proximity of oppositely charged electrodes and the multiplicity of electrodes configured in triads, that is, crisscross arrays of three.

### FIELD OF THE INVENTION

The present invention relates to a non-thermal, double dielectric barrier discharge (DDBD) type air treatment system, and more particularly, to an ozone-generating and airborne pollutants purification system and a carbon-based, plasma reactor device for use therein.

### BACKGROUND OF THE INVENTION

The use of plasma and its application for treatment of air and for production of ozone has been widely known for the past couple of decades. The performance of the plasma-based reactor depends on the type of electrical discharge, specifically known as micro-discharges, but the two terms are used interchangeably hereinafter for the sake of simplicity. The electrical discharge itself depends on the shape of electrodes, on the nature of the inter-electrode region, and on the voltage and current waveforms used for producing the plasma.

An electrical micro-discharge results in the flow of electrical current through a material that does not normally conduct electricity, such as air. On application of a high voltage source, the normally insulating air begins to exhibit conducting characteristics, and sparks, which are a form of electrical discharge, fly.

Normally, air consists of neutral molecules of nitrogen, oxygen and other gases, in which electrons are tightly bound to atomic nuclei. On application of an electric field above a threshold level, some of the electrons are separated from their host atoms, leaving them as positively charged ions. The electrons and the ions are then free to move separately under the influence of the applied electric field. Their movement constitutes an electric current. This ability to conduct electrical current is one of the more important properties of plasma.

Gas phase corona reactor (GPCR) technology enables the use of electrical discharges in order to excite electrons to very high energies, while the rest of the gas stays at ambient temperature. GPCRs of the DDBD type have historically been used to produce industrial quantities of ozone, which have been used in the air and water purification fields. This process also has wide application in the treatment of air-borne pollution.

Generally, DDBD electrodes exhibit boundary problems. The abrupt, step-like, change of the electrical potential at the conductor edges of the electrodes will lead to the undesired effect of arcing and subsequently to the degradation of the electrode set-up.

### SUMMARY OF THE INVENTION

It would be desirable to achieve an improved, effective, DDBD type electrode which can be used to produce electrical discharges in a plasma reactor core for an efficient and cost-effective air treatment process.

Accordingly, it is an object of the present invention to overcome the disadvantages of the prior art and provide a carbon-based electrode device and a DDBD system for air purification and the production of ozone. The air treatment system is designed, in one embodiment thereof, to be operational in a double stage cycle involving the production of ozone-enriched air and the disintegration of air-borne pollutants, in a first stage; and the decomposition of residual ozone in the air, in a second stage.

In DDBD systems, the energy density at a given voltage is inversely proportional to the distance between pairs of electrodes of opposite polarity. There is a significant drop in energy density as spatial separation from a discharge point is increased, such that energy becomes significantly lower even at short distances away from a discharge point. In the multi-electrode crisscross array of the present invention, the geometrical placement of the electrodes in triads increases the efficiency of the system via two parameters, the close proximity of oppositely charged electrodes and the multiplicity of electrodes configured in triads, that is, crisscross arrays of three.

Therefore, in accordance with a preferred embodiment of the present invention, there is provided a carbon-based electrode device comprising:

a hollow tube, sealed at both ends, the seals comprising a bulk of dielectric material;

a carbon filler material filling the hollow tube; and

a metallic wire being embedded in the carbon filler material and extending outwardly through one sealed end of the hollow tube so as to be connectable to an electrical circuit in a DDBD reactor core.

There is further provided an air treatment system for the production of ozone-enriched air, the disintegration of air-borne pollutants, and the decomposition of residual ozone in the air, the air treatment system comprising:

at least one air filter for filtering particulate matter;

a DDBD reactor core for subjecting air to non-thermal plasma, wherein the DDBD reactor core comprises a plurality of carbon-based electrode devices configured in an array of oppositely charged electrodes, wherein each carbon-based electrode device comprises:

a hollow tube, sealed at both ends, each seal comprising a bulk of dielectric material;

a carbon filler material filling the hollow tube; and

a metallic wire being embedded in the carbon filler material and extending outwardly through one sealed end of the hollow tube so as to be connectable to an electrical circuit in the DDBD reactor core;

a plurality of ozone filters for decomposition of ozone in the air;

a filter housing for mounting said plurality of ozone filters, wherein the filter housing provides diversion of inflowing air in one of two paths: a path through the plurality of ozone filters and a path directly through the at least one reactor core; and

at least one blower for drawing air into and through the air treatment system.

Additional features and advantages of the invention will become apparent from the following drawings and description.

### BRIEF DESCRIPTION OF THE DRAWINGS

For a better understanding of the invention with regard to the embodiments thereof, reference is made to the accompanying drawings (not to scale), in which like numerals designate corresponding sections or elements throughout, and in which:

FIG. 1A is an axial, cross-section view of a carbon-filled hollow tube, comprising a double dielectric barrier discharge electrode, sealed with bulk glass material at both ends, and constructed in accordance with the principles of the present invention in a preferred embodiment thereof;

FIG. 1B is an axial, cross-section view of another embodiment of the carbon-filled hollow tube of FIG. 1A;

FIG. 2 is a cross-section view of an open-air DDBD reactor core constructed in accordance with a preferred embodiment of the present invention;

FIG. 3 is a cross-section view of another embodiment of the device of FIG. 2, comprising a closed DDBD reactor core;

FIGS. 4A and 4B are axial end views of an electrical wiring circuit for an array of five electrodes arranged in a cylindrically shaped, closed-air DDBD reactor core constructed in accordance with another embodiment of the present invention;

FIGS. 5A and 5B are axial end views of another embodiment of the invention of FIG. 4;

FIGS. 6A and 6B are pictorial flow diagrams of a two-phase system for air treatment in accordance with a preferred embodiment of the invention; and

FIGS. 7A and 7B are pictorial flow diagrams of an alternate embodiment of the invention comprising a single air-blower system for ozone generation and air purification.

### DETAILED DESCRIPTION OF THE PREFERRED EMBODIMENTS

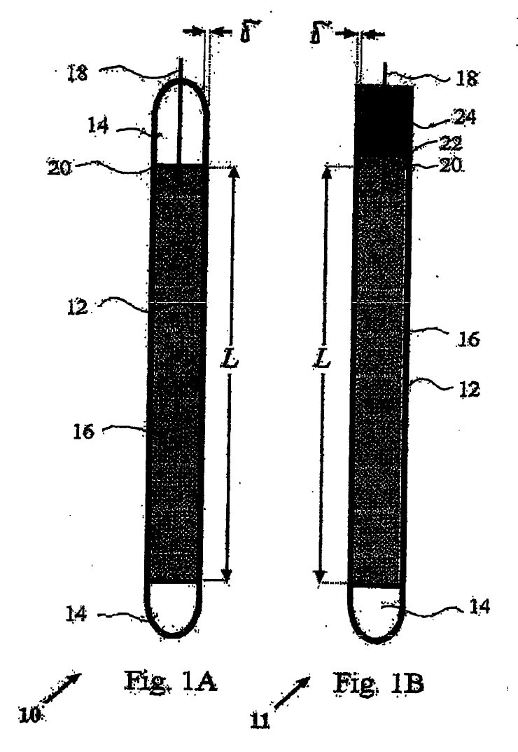

FIG. 1A is an axial, cross-section view of a carbon-filled hollow tube, comprising a DBDD electrode device, sealed with bulk glass material at both ends, and constructed in accordance with the principles of the present invention in a preferred embodiment thereof.

DDBD electrode device 10, comprises a hollow glass tube 12 of length L and thickness δ which is sealed at a first end by a bulk dielectric material, such as bulk-glass 14 in a preferred embodiment of the invention, of length between 15δ and 20δ, (depending on the applied high-voltage), and filled with a carbon filler 16. In the preferred embodiment illustrated in FIG. 1A, carbon filler 16 comprises granulated carbon, with granules preferably, but not necessarily, of cylindrical shape, but any spherical or multi-facet shaped grains in the dimensions of about 3-5 mm×1 mm diameter are usable.

At the second end of hollow glass tube 12, a metallic wire 18 is inserted, slightly penetrating the surface 20 formed by the carbon filler 16 while slightly extending outwardly from the second end of hollow glass tube 12 to provide for a connection to a lead wire connecting the electrode device 10 to an electric power source (not shown). The second end of hollow glass tube 12 is then completely sealed with a bulk dielectric material, such as bulk-glass 14 in a preferred embodiment of the invention, which is poured in a liquid state surrounding the extension of metallic wire 18 during air evacuation of the tubular volume.

FIG. 1B is an axial, cross-section view of another embodiment of the carbon-filled hollow tube of FIG. 1A.

In this embodiment of the invention, a hollow glass tube 12, of length L and thickness δ, corked at a first end with a bulk dielectric material, such as bulk glass 14 in a preferred embodiment of the invention, is filled with carbon filler 16 to form a surface 20 inside hollow glass tube 12 which is then plugged with a first cork 22 made of any highly electrical insulating and flexible material, such as Teflon or Polyurethane. In the preferred embodiment of the invention illustrated here, first cork 22 is made of poured flexible Polyurethane.

A metallic wire 18 is inserted at the end of hollow glass tube 12 so as to penetrate first cork 22 and slightly penetrate the surface 20 of the carbon filler 16 while extending outwardly from the hollow glass tube 12 and thus providing for a connection to a lead wire (not shown) enabling the electrode device device 11 to be connected in an electrical wiring circuit of a reactor core.

A second cork 24, made of any highly electrical insulating and hard material, is applied to surround and seal the metal wire 18 into position. In a preferred embodiment of the invention, second cork 24 is made of poured hard Polyurethane. Second cork 24 is poured directly into glass tube 12 from the liquid phase and, until it hardens, is prevented from leaking into carbon filler 16 by the presence of first cork 22.

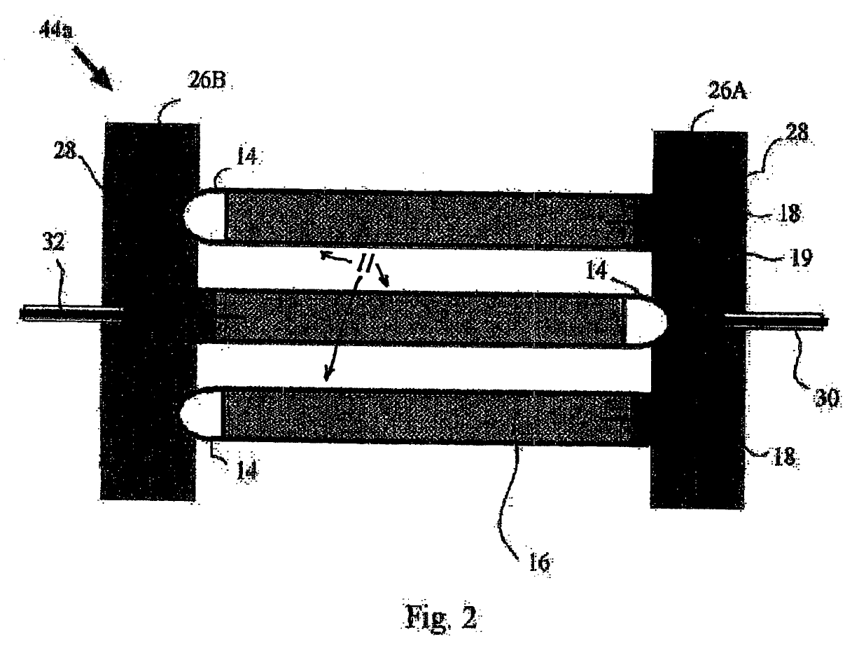

FIG. 2 is a cross-section view of an open-air DDBD reactor core constructed in accordance with a preferred embodiment of the present invention.

A plurality of the carbon-based electrode device 11 from FIG. 1B are shown in a cross-section view illustrating an arrangement of the electrodes in three, parallel rows with a center electrode device 11 being disposed in a reverse orientation in relation to the surrounding outer-disposed electrodes most closely adjacent to the center electrode device 11. The plurality of electrode devices 11 are mounted and fixedly held in parallel to each other between two supporting bars 26A and 26B (hereinafter generally designated 26A/B) which are manufactured with holes (not shown) to accommodate and support the ends of each of the plurality of electrode devices 11. The resulting structure comprises a DDBD reactor core 44a constructed in accordance with a preferred embodiment of the invention.

The supporting bars 26A/B may be made of PVC, Teflon, ceramic material, or any other highly electrical insulating material, but in the preferred embodiment shown in FIG; 2, the supporting bars 26A/B are made of PVC. The supporting bars 26A/B may be made in any appropriate shape to accommodate and support the plurality of electrode devices 11, but in a preferred embodiment of the invention, are formed as rectangular blocks with tub-like recesses 28 provided in the outer facets of supporting bars 26A/B, which face away from one another.

The plurality of electrode devices 11 are mounted in an alternating array forming at least one triad, or group of adjacent, oppositely charged electrodes comprising DDBD reactor core 44A, as illustrated by way of example in the cross-section view of FIG. 2. In actual practice, any number of triads of electrode devices 11 can be mounted in a fixed array to form a DDBD reactor core, the number depending on the scale of operation required for efficient and effective air treatment.

In supporting bars 26A/B, the inner facet is perforated by a crisscross arrangement of three holes (not shown) which exactly match the diameter of each, carbon-filled, hollow glass tube 12 (see FIG. 1) comprising the triad of electrode devices 11. The holes accommodating the ends of electrode devices 11 bearing a protruding electrical wire 18 run through the entirety of bars 26A/B, extending outward into the tub-like recess 28 formed in the outer facets of bars 26A/B. The holes accommodating the bulk-glass 14 ends of the electrode devices 11 do not extend into the tub-like recesses 28 in the outer facets of bars 26A/B, but rather are drilled only to the extent of providing mechanical support for the bulk-glass 14 ends.

After mounting electrode devices 11 in supporting bars 26A/B and wiring the electrode devices 11 to lead wires 30 and 32, the tub-like recesses 28 in the supporting bars 26A/B are filled with a liquid phase dielectric material which hardens in place filling the volume of the tub-like recesses 28. It should be noted that the liquid phase filler material, in a preferred embodiment of the invention, comprises poured hard Polyurethane and is identical to the material used in second cork 24 already hardened and in place surrounding an extension of metallic wires 18 embedded in the carbon filler material 16 as described heretofore in reference to FIG. 1.

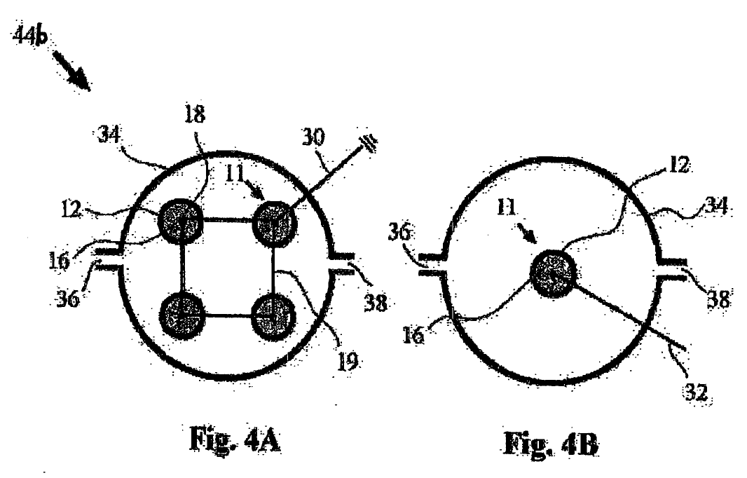

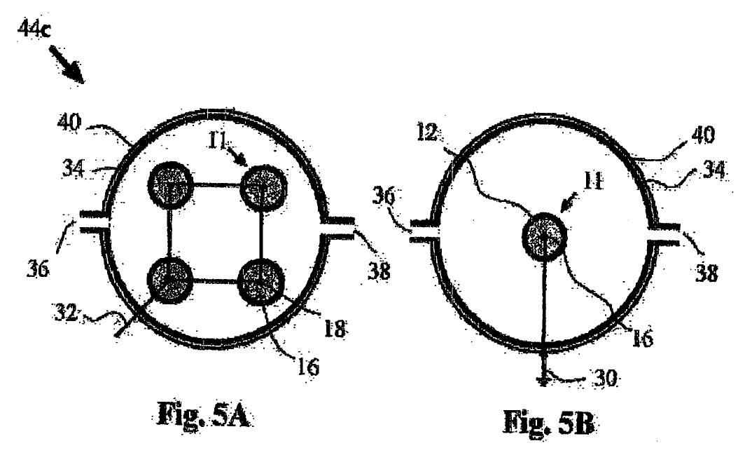

Each of the metallic wires 18 that protrude from the outer-positioned electrode devices 11 of DDBD reactor core 44a extending into the tub-like recesses 28 of supporting bar 26A are internally interconnected by conducting wires 19, made of copper wire, to join like, electrically charged terminals to a lead cable. In general, the outermost electrode devices 11 are connected to a ground lead 30, primarily for safety reasons. (The interconnecting wires 19 are arranged, in preferred embodiments of the invention, as shown in FIGS. 4 and 5, described hereinafter.) The metallic wire 18 in the electrode device 11 extending through supporting bar 26B is internally connected directly to another cable, in this example, comprising a high voltage lead 32 connectable to a power supply (not shown).

In another embodiment of the present invention (not illustrated) the middle electrode and the respective holes are of a different (smaller/greater) diameter than the outer electrodes and their respective holes. The thickness of each of the carbon-filled, hollow glass tubes 12 comprising the plurality of electrode devices 11, as indicated generally by the symbol δ (as in FIG. 1), is identical. The ratio between the diameter of the middle electrode and the outer electrodes is determined by the gap distances between adjacent and oppositely poled electrodes with respect to given applications.

The gap distance between adjacent and oppositely poled electrodes is itself set in accordance with the respective application. For ozone generation, the gap is set between 1 mm and 2 mm. On the other hand, for gas, or air purification treatment, the gap is set between 2 mm and 6 mm.

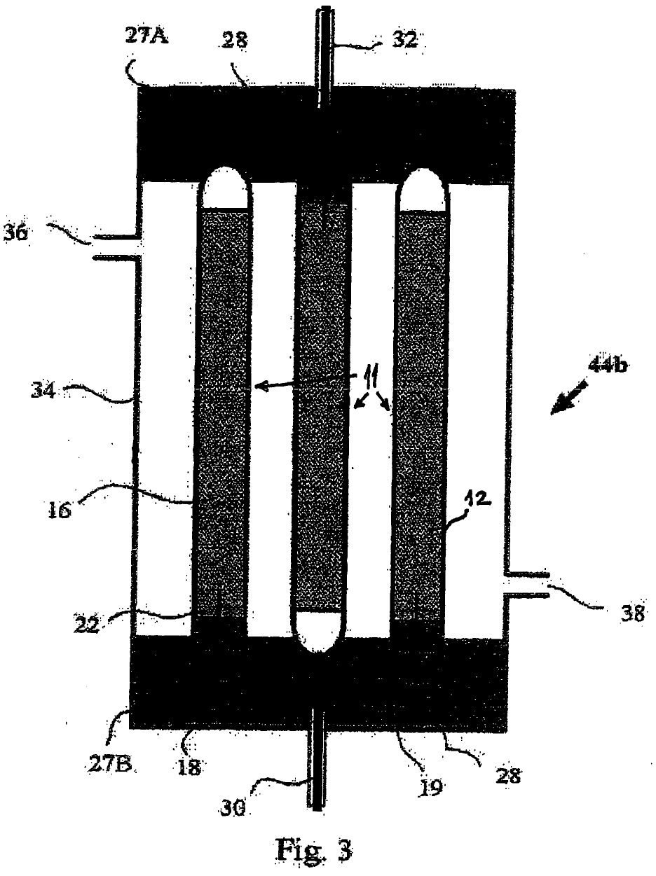

FIG. 3 is a cross-section view of another embodiment of the device of FIG. 2, comprising a closed DDBD reactor core constructed in accordance with the principles of the present invention.

The internal elements of the reactor core 44b are essentially identical to those shown in FIG. 2, but the array of electrode devices 11 are enclosed in a cylindrically-shaped, sealed glass jacket 34 to accommodate the entry of air or gas for treatment. The glass jacket 34 is provided with an inlet 36 and outlet 38 comprising glass nozzles for feeding source gases, such as air, pure oxygen or a contaminated air stream, as the case may be. The circulating gas serves also as a coolant for cooling the DDBD reactor core 44b.

The diameter of glass jacket 34 is chosen so as to maintain the same gap distance between its inner diameter and the nearest surface of the most outwardly disposed carbon-based electrode devices 11 surrounding the centrally disposed electrode device 11. The thickness of the glass jacket 34 is identical to that of each of the carbon-filled, hollow glass tubes 12 comprising each of the electrode devices 11.

The extension of metallic wire 18 from the middle positioned electrode device 11 in supporting bar 27A is internally and directly connected to a first lead wire 32, whereas the extensions of metallic wires 18 from the outwardly positioned electrode devices 11 extending into the tub-like recess 28 of supporting bar 27B are internally interconnected by conducting wires 19, made of copper wire and joined to a second lead wire 30. The first lead wire 32 and the second lead wire 30 are then connectable to a power source (not shown) for operation of the DDBD reactor core 44b.

In an alternate embodiment of the invention of FIG. 3 (not shown), the glass jacket 34 is covered with an external conductive layer 40, as shown in the wiring circuit in FIG. 5B, which is electrically connected to a ground 30 as shown in FIG. 5B.

FIGS. 4A and 4B are axial end views of an electrical wiring circuit for an array of five electrodes arranged in a cylindrically shaped, closed-air DDBD reactor core constructed in accordance with another embodiment of the present invention.

Referring now to FIG. 4A, there is shown an axial end view of an arrangement for the interconnection of wires 19 among four carbon-based electrode devices 11 constructed in accordance with the principles of the invention and described in reference to FIG. 1B. Carbon-based electrode devices 11 are disposed in an array within a glass enclosure 34 forming a cylindrically shaped, closed air DDBD reactor core 44b provided with gas inlet 36 and outlet 38. Four of the carbon-based, electrode devices 11 are further interconnected to a ground lead 30 by connecting wires 19.

The four outwardly positioned, carbon-based electrode devices 11 are interconnected by connecting wires 19 and supported in a circular end cork generally defined by the inner walls of glass enclosure 34. The circular end cork is formed from poured liquid phase Polyurethane that hardens to a concave shape filling the volume within the glass enclosure 34 above the inlet 36 and outlet 38 of the glass enclosure 34. The poured dielectric material embeds the connecting wires 19 while providing support to maintain fixed gaps between the four outwardly positioned electrode devices 11 and a centrally positioned electrode device 11 (see FIG. 4B). FIG. 4B is an axial view of the opposite end of DDBD reactor core 44b of FIG. 4A, illustrating the electrical connection for a high-voltage lead 32 extending from a fifth, centrally positioned electrode device 11 in the array of five, in accordance with a preferred embodiment of the invention. The electrode device 11 in FIG. 4B is disposed in a reverse end orientation and is of opposite polarity in respect to that of the four surrounding electrode devices 11 shown in FIG. 4A.

FIGS. 5A and 5B are axial end views of another embodiment of the invention of FIG. 4.

In this embodiment of the invention, an electrically conductive coating 40 is applied over the insulating jacket 34 of the cylindrical, closed-air DDBD reactor core 44c. In FIG. 5B the ground lead 30 is also connected to the layer of conductive coating 40 making it part of the electrical wiring circuit and increasing the output of micro-discharges along the length of the glass enclosure 34 when the reactor core 44c is connected to a power supply (not shown). Other like-numbered elements in the embodiment of the invention shown in FIG. 5 are substantially as described in reference to FIG. 4.

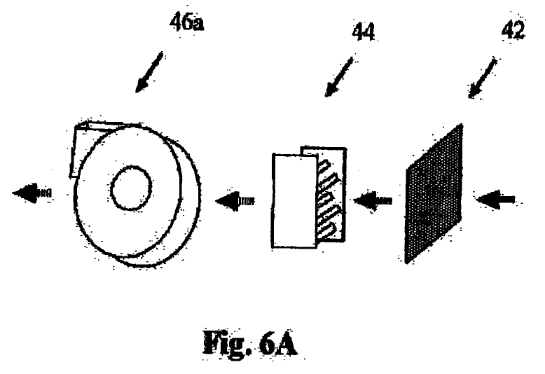

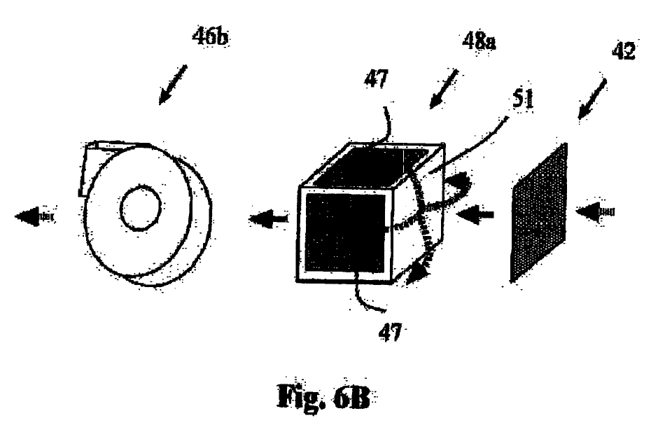

FIGS. 6A and 6B are pictorial flow diagrams of a two-phase system for air treatment in accordance with a preferred embodiment of the invention.

FIG. 6A is a pictorial flow diagram of the first, ozone-generating phase in the air treatment system, and FIG. 6B is a pictorial flow diagram of the second, ozone-decomposition phase in the system of air treatment of FIG. 6A.

In FIG. 6A, the first, ozone-generating phase of the air treatment system, normal air, indicated by a series of horizontal arrows depicting an air stream, is drawn through a dust filter 42 for filtering out particulate matter in the entering air for efficient operation of the air treatment system. The filtered air is then passed through a DDBD reactor 44, examples of which were described heretofore. The DDBD reactor 44 is constructed in accordance with the principles of the present invention so as to efficiently produce ozone-enriched air. A first, standard type, air blower 46a is used to draw air into the air treatment system and to pull the air through DDBD reactor 44.

FIG. 6B is a pictorial flow diagram of the second phase of operation of the air treatment system of FIG. 6A. A second air blower 46b pulls the ozone-enriched air (arrows indicate the air flow) through a dust filter 42 and towards a filter housing 48a where the dust-filtered air is pulled through a plurality of catalytic ozone filters 47 mounted in the filter housing 48a. The filter housing 48 is provided with a sealed baffle 51 so that incoming air is directed through multiple passages in ozone filters 47 to maximize the catalytic action. The treated air is then exhausted from the air treatment system by action of a second air blower 46b.

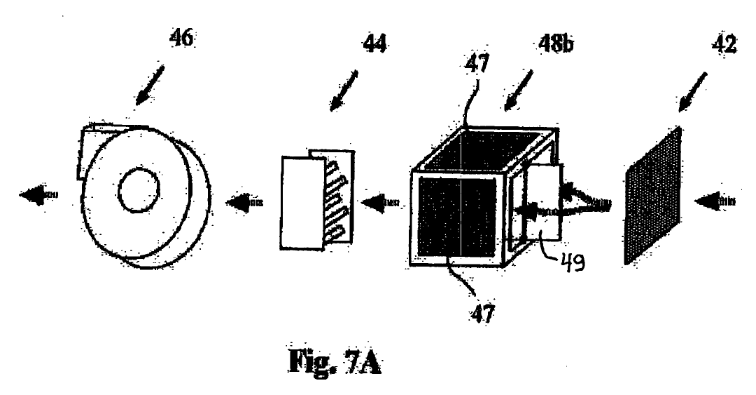

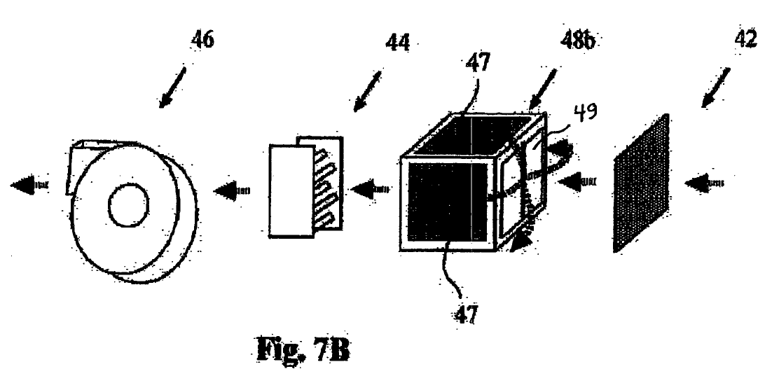

FIGS. 7A and 7B are pictorial flow diagrams of an alternate, preferred embodiment of the invention comprising a single air-blower system for ozone generation and air purification. Because there is only one air blower 46 required, this alternate embodiment of the invention is much more economical to operate, although it functions in two cycles for complete air treatment.

In FIG. 7A, depicting the ozone-generating, first cycle of operation, normal air (shown by horizontal arrows representing an air stream) is drawn into a dust filter 42 and directed into a filter housing 48b which supports a plurality of ozone filters 47. The entering air passes directly through a filter housing 48b whose front flap 49 is in an open position. Thus the air is not in contact with or treated by the plurality of ozone filters 47. The normal air is pulled by blower 46 through a DDBD reactor 44 constructed and operated in accordance with the principles of the invention as hereinbefore described, producing ozone-enriched air.

In FIG. 7B, depicting the air purification, second cycle of operation, the ozone-enriched air from the first cycle of operation shown in FIG. 7A, indicated by the horizontal arrows, is then recycled by being passed through dust filter 42 until the air encounters the front flap 49 of filter housing 48b which is now in a closed position so as direct the air stream into a plurality of ozone filters 47 which are activated. The dust-free, incoming ozone-enriched air stream (shown by multidirectional arrows) is forced to pass through many contact points within the active catalytic elements of the ozone filters 47 before being drawn out of the air treatment system by air blower 46. Incidental to being exhausted from the air treatment system, the exhausted air passes through the DDBD reactor 44 which is in line, but now set to an off operating status, since it is not needed in this second cycle of operation.

Having described the present invention with regard to certain specific embodiments thereof, it is to be understood that the description is not meant as a limitation, since further modifications may now suggest themselves to those skilled in the art, and it is intended to cover such modifications as fall within the scope of the described invention.

We claim:

1. A carbon-based electrode device comprising:
a hollow tube, sealed at both ends, the seals comprising a bulk of dielectric material;
a carbon filler material filling said hollow tube; and
a metallic wire being embedded in said carbon filler material and extending outwardly from one end of said hollow tube through the bulk of dielectric material so as to be connectable to an electrical circuit in a DDBD reactor core.

2. An air treatment system for the production of ozone-enriched air, the disintegration of air-borne pollutants, and the decomposition of residual ozone in the air, said air treatment system comprising:
at least one air filter for filtering particulate matter;
at least one DDBD reactor core for subjecting air to non-thermal plasma, wherein said at least one DDBD reactor core comprises a plurality of carbon-based electrode devices configured in an array of oppositely charged electrodes, wherein each of said carbon-based electrode devices comprises:
a hollow tube, sealed at both ends, each seal comprising a bulk of dielectric material;
a carbon filler material filling said hollow tube; and
a metallic wire being embedded in said carbon filler material and extending outwardly through one sealed end of said hollow tube so as to be connectable to an electrical circuit in said at least one DDBD reactor core;
a plurality of ozone filters for decomposition of ozone in the air;
a filter housing for mounting said plurality of ozone filters, wherein said filter housing provides diversion of inflowing air in one of two paths: a path through said plurality of ozone filters and a path directly through said at least one reactor core; and
at least one blower for drawing air into and through said air treatment system.
